(19) United States
(12) Patent Application Publication
(10) Pub. No.: US 2011/0161898 A1
(43) Pub. Date: Jun. 30, 2011

(54) Synthesizing Checkers from Nondeterministic Finite Automaton

(76) Inventors: Rahul Chauhdry, Portland, OR (US); Andrew Seawright, Lake Oswego, OR (US)

(21) Appl. No.: 12/873,234

(22) Filed: Aug. 31, 2010

Related U.S. Application Data
(60) Provisional application No. 61/238,631, filed on Aug. 31, 2009.

(51) Int. Cl. G06F 17/50

(52) U.S. Cl. 716/103

(57) ABSTRACT

The present invention provides for the generation of non-deterministic checker circuits. for use in formal verification of electronic designs. In various implementations, an assertion is first received, subsequently; a failure sequence is derived from the assertion. After which, a non-deterministic finite automaton is derived from the failure sequence. Lastly, a checker circuit is generated directly from the non-deterministic finite automaton.

### RELATED PATENT APPLICATIONS

The present application claims priority under 35 U.S.C. §119 to U.S. Provisional Patent Application No. 61/238,631, entitled “Synthesize Long-Delay SVA/PSL Constructs with Counter and Non-Determinism,” filed on Aug. 31, 2009 and naming Andrew Seawright et al. as inventors, which application is incorporated entirely herein by reference.

### FIELD OF THE INVENTION

The invention relates to the field of electronic design verification. More particularly, various implementations of the invention are applicable to synthesizing checkers from assertions.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit, i.e. that the logical design conforms to the specification. This analysis is sometimes referred to as “formal verification.”

After the logical design is verified, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, often mathematically, to confirm that the circuit described by the device design conforms to the logical design, and as a result, the specification. This analysis is also sometimes referred to as formal verification. Additional verifications, such as for example timing and power verifications are often made at this stage, and may be included in the formal verification process.

Once the components and their interconnections are established, the design is again transformed, this time into a physical design that describes specific geometric elements. The geometric elements, which typically are polygons, define the shapes that will be created in various layers of material to manufacture the circuit. This type of design often is referred to as a “layout” design. The layout design is then used as a template to manufacture the integrated circuit. More particularly, the integrated circuit devices are manufactured, by for example an optical lithographic process, using the layout design as a template. During an optical lithography process, a photo-mask is used to transfer a geometric pattern from the photo-mask onto a substrate via a photo-resistive material. The geometric pattern in the photo-mask is designed such that the image or pattern transferred onto the substrate matches the geometric pattern of the layout design.

As indicated above, formal verification is used to ensure the device design complies with the device specification. The specification often defines properties and directives that collectively describe the expected behavior of the device. The specification of properties and directives is often done semantically. Various languages exist for defining properties and directives, such as for example Sugar, ForSpec, Property Specification Language (PSL), and System Verilog Assertions (SVA), among others. As stated above, the device design is often in the form of a hardware description language. Formal verification then either proves or disproves the properties and directives with respect to the design and the specification.

### SUMMARY OF THE INVENTION

Implementations of the invention provide methods and apparatuses for generating a non-deterministic checker from an assertion. In various implementations, an assertion is first received, subsequently, a failure sequence is derived from the assertion. After which, a non-deterministic finite automaton is derived from the failure sequence. Lastly, a checker circuit is generated directly from the non-deterministic finite automaton.

These and additional implementations of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 shows an illustrative formal verification tool;

FIG. 2 a device design;

FIG. 3 illustrates a clock signal;

FIG. 4 shows an illustrative computing device

FIG. 5 illustrates a method of generating an auxiliary verification property;

FIG. 6 illustrates the method of FIG. 5 in greater detail;

FIG. 7 illustrates the method of FIG. 6 in greater detail;

FIG. 8 illustrates an electronic system;

FIG. 9 illustrates a description of a portion of the electronic system of FIG. 8;

FIG. 10 illustrates a description of the power domains of the electronic system of FIG. 8;

FIG. 11A illustrates logic states for the electronic system of FIG. 8; and

FIG. 11B illustrates logic states for the electronic system of FIG. 8.

### DETAILED DESCRIPTION OF ILLUSTRATIVE IMPLEMENTATIONS

Although the operations of the disclosed techniques are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular techniques can be used in conjunction with other techniques. Additionally, the detailed description sometimes uses terms like “determine” to describe the disclosed techniques. Such terms are high-level abstractions of the actual operations that are performed. The actual operations that correspond to these terms will vary depending on the particular implementation and are readily discernible by one of ordinary skill in the art.

Some of the techniques described herein can be implemented by software stored on a computer readable storage medium and executed on a computer. Additionally, some of the disclosed techniques may be implemented as part of a computer implemented electronic design automation (EDA) tool. The selected techniques could be executed on a single computer or a computer networked with another computer or computers. For clarity, only those aspects of the tools or computer germane to these disclosed techniques are described; product details well known in the art are omitted.

Formal Verification

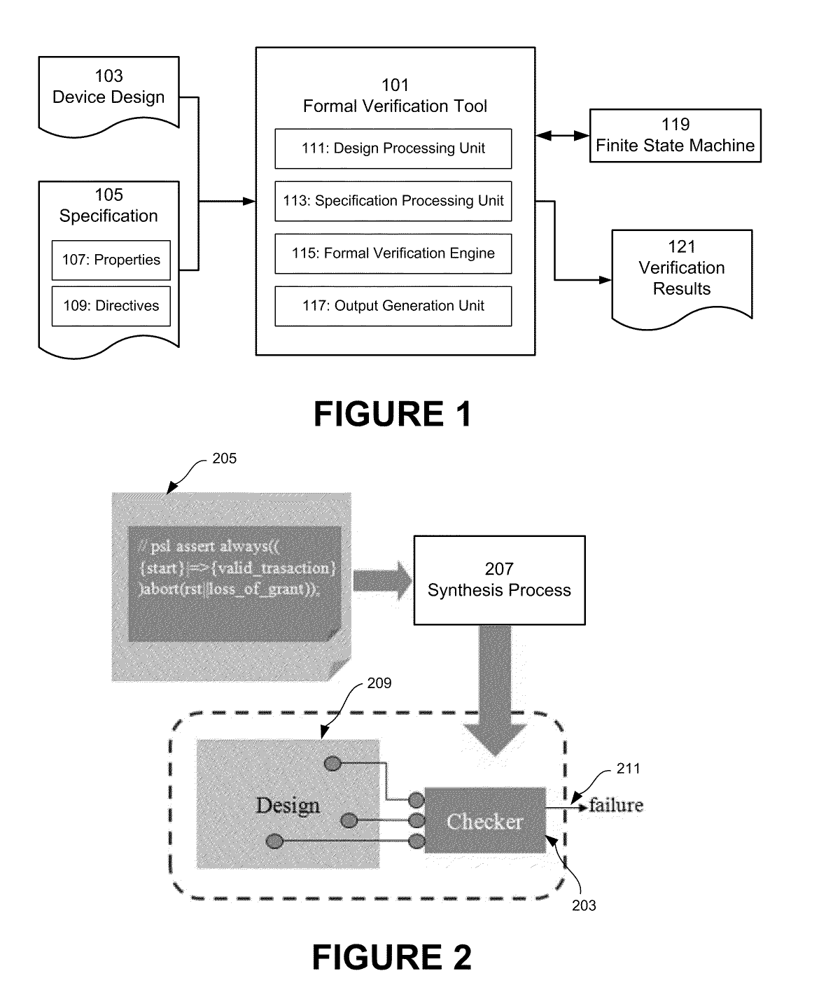

As the described techniques apply to synthesizing “checkers” to be used during formal verification, a general formal verification tool and process are described here. FIG. 1 illustrates a formal verification tool 101. The formal verification tool 101 may be employed to prove or disprove that the device design 103 conforms to the specification 105. As can be seen from this figure, the specification 105 includes a set of properties 107 and a set of directives 109. The set of properties 107 is a collection of logical and temporal relationships that combined represent a set of behavior, rules, or characteristics about the design 103. The set of directives 109 specify the specific actions to be taken to “check” the set of properties. For example, a common directive is the assert directive. The assert directive states that a given property is required to hold in a given set of states, and directs the formal verification tool 101 to verify that the property does hold the given states. Various other directives, such as for example the cover directive or the assume directive, are available for checking selected properties. Those of skill in the art are familiar with properties and directives and the various languages available for declaring properties and directives. Accordingly, these are not reviewed here.

As further illustrated in FIG. 1, the formal verification tool 101 includes a design processing unit 111, a specification processing unit 113, a formal verification engine 115, and an output generation unit 117. The design processing unit 111 may access the design 103 and generate a finite state machine 119. In some implementations, other mathematical descriptions of the design, such as for example non-deterministic automata may be generated. The specification processing unit 113 accesses the specification 105 and from set of properties 107 and the set of directives 109 generates one or more checkers 123. In various implementations, the checkers are finite state machines that detect invalid states within a design. As used herein, a “checker” is any logic or formula that is used to determine when ones of the set of properties 107 and directives 109 have been violated. The formal verification engine 115 takes the checkers 123 and determines, often mathematically, if a directive is satisfied or not. More particularly, the formal verification engine 115 either proves or disproves ones of the set of directives 109 for the corresponding properties of the set of properties 107, based on the finite state machine 119.

The output generation unit 117 generates a report 121 that may be made available to the user, by for example storing it to a memory storage location or outputting to a visual display device. In various implementations, the report 121 lists the specific directives and which were proven true and which were proven false. In further implementations, for the directives proven false, a listing of the states that caused the directive to fail may be included in the report 121. In still various implementations, the directives that could not be proven or disproven may be included in the report 121.

As FIG. 1 illustrates, formal verification is typically applied to device designs. However, formal verification may be applied to already manufactured devices, such as for example a prototype device. The techniques described herein for verifying the power state transition of a device design are equally applicable to verification of a physical design. However, for purposes of brevity and clarity, a distinction between verification at the design level and at the physical level is not made in the balance of this disclosure. Furthermore, the term device may be used interchangeably to refer to a physical embodiment of the device as well as to models or representations of the device.

Directives and Properties

As detailed above, the set of directives 109 are checks of various ones of the properties 107 that relate to the device design 103. Those of skill in the art can appreciate that in formal verification, properties and directives are used in conjunction with each other to verify a design. More particularly, directives, which are sometimes referred to as verification statements, are instructions that specify what to do with the properties. For example, a simple verification statement is assert property (a ##1 b). As can be seen, this statement is an assert directive, which instructs the verification tool to verify that the property statement (i.e. a ##1 b) holds. In this case the tool is instructed to verify that every occurrence of a is followed by b. As used herein, the term verification statement refers to a property definition and a corresponding verification directive. Additionally, as those of skill in the art can appreciate, a specification for use in formal verification includes both property definitions and corresponding directives.

As stated above, various languages exist for defining the properties and directives that make up the specification. One such language is the system verilog assertion language. Most languages used to define properties and directives can be translated into a temporal logic form, such as for example linear temporal logic. Linear temporal logic is a modal form of temporal logic, where the modalities refer to time. Linear temporal logic is built from a set of propositional variables, logical connections, and modal operators. For example, X pv1 states that the variable pv1 has to hold in the next state. Additionally, pv1 U pv2 states that the variable pv1 has to hold at least until pv2. Furthermore, various operators may be classified as “weak” or “strong”. As used herein a strong operator requires that the terminating condition (i.e. the occurrence of pv2 in the above example) occur. Often, a strong operation may be indicated by the symbol “!”, for example pv1 U! pv2. An example of a weak operator is pv1 W pv2, which is the equivalent of (pv1 U pv2) V G pv1, which means that either pv1 has to hold at least until pv2 or pv1 holds indefinitely.

In addition to the weak and strong operators. Linear temporal logic properties of “liveness” and “safety” are often used. The safety property specifies that “nothing bad happens,” while the liveness property specifies that “something good will happen.” In general these two properties are actually aspects of the properties and directives of the specification. Accordingly, as those of skill in the art can appreciate, there are various “classes” of properties, such as for example the liveness class of properties. The details of performing formal verification by using the liveness and safety classes of properties are familiar to those of skill in the art and as such will not be further covered in detail here.

Checker Generation

As discussed, a checker is often used to formally verify that an electronic design complies with specific properties and directives. In various implementations, a checker is synthesized from a set of properties. For example, FIG. 2 illustrates a checker 203 that is synthesized from a property statement 205 by a synthesis process 207. As can be seen from this figure, the checker 203 can be connected to a design 209 such that when the design is “run” (i.e. simulated, executed, or emulated) the checker 203 will generate a signal 211 if the property statement 205 is violated. Often, the signal 211 is referred to as a “fire signal.”

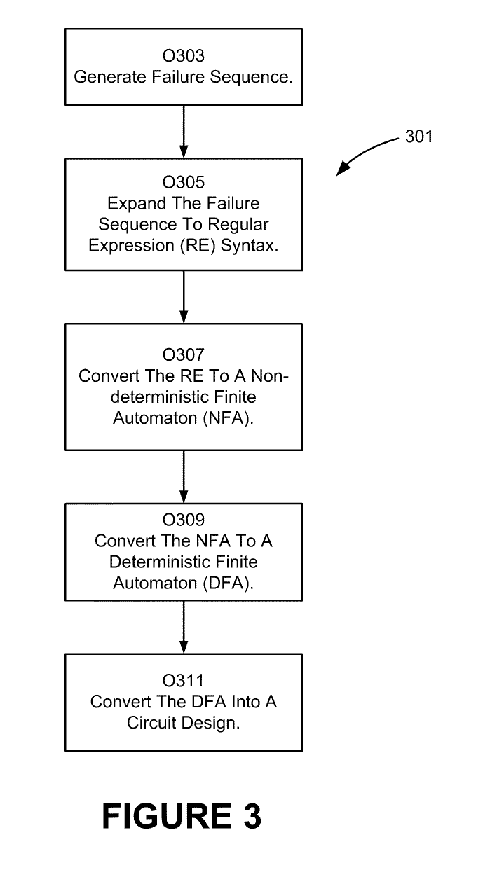

FIG. 3 illustrates a method 301 of synthesizing a checker. As can be seen from this figure, the method 301 includes an operation 303 for converting a property into a “failure sequence.” More particularly, consider the following property P:
P=always{a; b; c; d}|=>{e};

A corresponding failure sequence R for the property P, which means that the property P holds if and only if R never occurs may be:
{R}={[*]; a; b; c; d; !e} false

Various techniques exist for generating a failure sequence from a property. For example, On-The-Fly Model Checking of RCTL Formulas, by IIan Beer et al., Lecture Notes on Computer Science, 1998, Volume 1427, pp. 184-194, which article is incorporated entirely herein by reference teaches methods of generating failure sequences from properties. Particularly, this article teaches generating failure sequences in RCTL form from a properly in either System Verilog Assertion (SVA) from or Property Specification Language (PSL) form.

Subsequently, the method 301 includes an operation 305 for expanding the failure sequence into regular expression syntax, an operation 307 for converting the regular expression into a non-deterministic finite automaton (NDA), an operation 309 for converting the NDA into a deterministic finite automaton (DFA), and an operation 311 for converting the DFA into a circuit. Typically, the circuit will include registers and next state logic such that the register values corresponding to the final state of the deterministic finite state machine become the fire signal for the property. Accordingly, the property can now be checked by formal verification tools. As those of skill in the art can appreciate, many techniques exists for performing the operations 303 through 311, as such, possible techniques are not discussed herein.

However, it is important to point out significant disadvantageous to the method 301. Assuming that the size of the regular expression after expansion by the operation 305 is equal to n, the size of the non-deterministic finite automaton obtained by the operation 307 would have approximately n states as well. Accordingly, the deterministic finite automaton obtained by the operation 309 would have 2ⁿ states. A deterministic finite automaton with 2ⁿ states needs n registers to encode all of its states. As a result, the circuit (i.e. the checker circuit) generated by the operation 311 requires n registers. It follows that the size of the checker circuit is linear in proportion to the size of the expanded regular expression. However, the state space of the checker circuit is exponential in relation to the expanded regular expression. As a result, the memory requirements for determining the checker circuit increase exponentially with the size of the regular expression. More particularly, as the size of the deterministic finite automaton is 2ⁿ, and the deterministic finite automaton must be saved to a memory storage location prior to being converted to the checker circuit, the memory requirements for deriving a checker circuit are 2ⁿ where there are n states in the expanded regular expression.

Illustrative Computing Environment

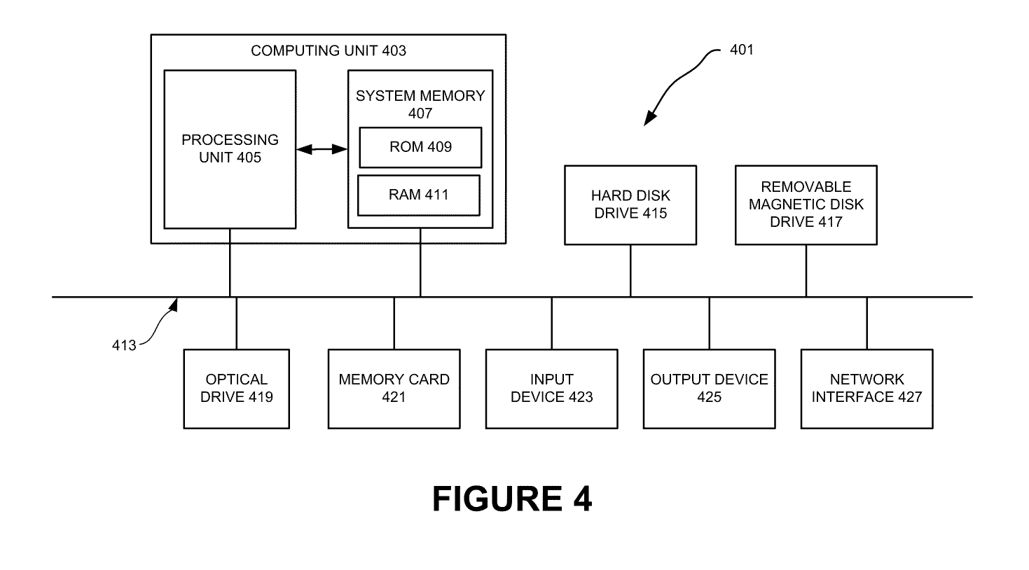

As the techniques of the present invention may be implemented using software instructions, the components and operation of a generic programmable computer system on which various implementations of the invention may be employed is described. Accordingly, FIG. 4 shows an illustrative example of a computing device 401. As seen in this figure, the computing device 401 includes a computing unit 403 with a processing unit 405 and a system memory 407. The processing unit 405 may be any type of programmable electronic device for executing software instructions, but will conventionally be a microprocessor. The system memory 407 may include both a read-only memory (ROM) 409 and a random access memory (RAM) 411. As will be appreciated by those of ordinary skill in the art, both the read-only memory (ROM) 409 and the random access memory (RAM) 411 may store software instructions for execution by the processing unit 405.

The processing unit 405 and the system memory 407 are connected, either directly or indirectly, through a bus 413 or alternate communication structure, to one or more peripheral devices. For example, the processing unit 405 or the system memory 407 may be directly or indirectly connected to one or more additional memory storage devices, such as a “hard” magnetic disk drive 415, a removable magnetic disk drive 417, an optical disk drive 419, or a flash memory card 421. The processing unit 405 and the system memory 407 also may be directly or indirectly connected to one or more input devices 423 and one or more output devices 425. The input devices 423 may include, for example, a keyboard, a pointing device (such as a mouse, touchpad, stylus, trackball, or joystick), a scanner, a camera, and a microphone. The output devices 425 may include, for example, a monitor display, a printer and speakers. With various examples of the computer 401, one or more of the peripheral devices 415-425 may be internally housed with the computing unit 403. Alternately, one or more of the peripheral devices 415-425 may be external to the housing for the computing unit 403 and connected to the bus 413 through, for example, a Universal Serial Bus (USB) connection.

With some implementations, the computing unit 403 may be directly or indirectly connected to one or more network interfaces 427 for communicating with other devices making up a network. The network interface 427 translates data and control signals from the computing unit 403 into network messages according to one or more communication protocols, such as the transmission control protocol (TCP) and the Internet protocol (IP). Also, the interface 427 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 401 is illustrated as an example only, and it not intended to be limiting. Various embodiments of the invention may be implemented using one or more computing devices that include the components of the computer 401 illustrated in FIG. 4, which include only a subset of the components illustrated in FIG. 4, or which include an alternate combination of components, including components that are not shown in FIG. 4. For example, various embodiments of the invention may be implemented using a multi-processor computer, a plurality of single and/or multiprocessor computers arranged into a network, or some combination of both.

Synthesizing Checkers Directly from Non-Deterministic Finite Automaton

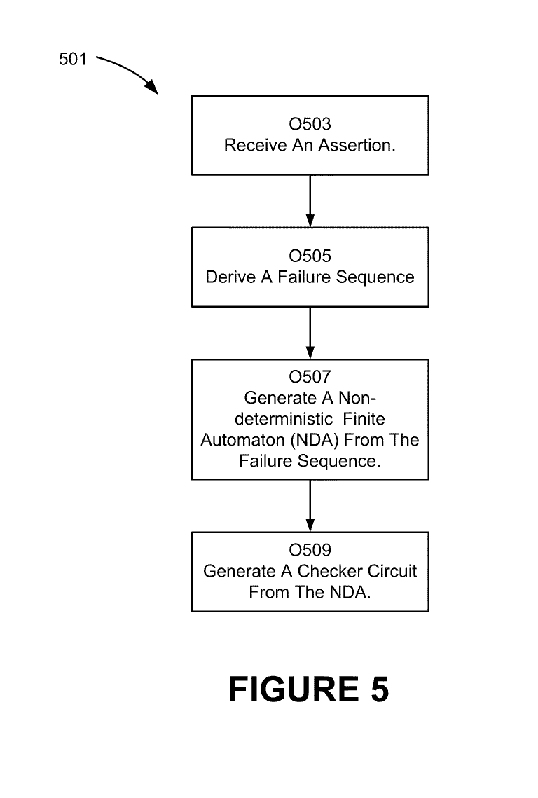

FIG. 5 illustrates a method 501 that may be provided by various implementations of the present invention to generate a checker from a non-deterministic finite automaton. As can be seen from this figure, the method 501 includes an operation 503 for receiving an assertion, an operation 505 for deriving a failure sequence from the assertion, an operation 507 for generating a non-deterministic finite automaton from the failure sequence, and an operation 509 for generating a checker circuit from the non-deterministic finite automaton.

Illustrative Application

Consider the following Property Specification Language (PSL) property:
default clock=(posedge(clk));
property p={x; [*128]}|−>{!x};
assert always p;

This property states that is ‘x’ is true at any time ‘t’, then at time ‘t+128’, ‘x’ must be false. The following failure sequence may be generated from this property:
{[*]; x; [*127]; x} (false)

A conventional implementation, such as, for example, the method 301 of FIG. 3, may generate a deterministic checker circuit as follows:

wire dfire;
reg [127:0] dstate;
initial dstate <= 128′b0;
always @(posedge clk)

dstate <= {dstate[126:0], x};

assign dfire = dstate{127} && x;

As can be appreciated, “dfire” is the signal used during simulation or formal verification to check the property. It is important to note also that the checker circuit has 128 registers, and hence 2ⁿ states. As all of these states are distinct, this circuit cannot be reduced or optimized by the different minimization algorithms that exist.

Various implementations of the present invention may generate a non-deterministic checker circuit as follows:

wire ndfire;
reg [7:0] ndstate;
reg ndstarted;
reg ndfloating;
initial ndstate <= 8′b0;
initial ndstarted <= 1′b0;
always @(posedge clk)

begin
if(x)

if(ndfloating)

ndstarted <= 1′b1;

if(ndstarted && ndstate < 8′d128)

ndstate <= ndstate + 8′b1;

end

assign ndfire = (ndstate == 8′d127) && x;

The “ndfire” signal may then subsequently be used during formal verification to check the property.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A method for generating a non-deterministic checker circuit for use in formal verification, the method comprising:
receiving an assertion;
deriving a failure sequence from the assertion;
deriving a non-deterministic finite automaton from the failure sequence; and
generating a checker circuit based that corresponds to the non-deterministic finite automaton.
